(19) United States
(12) Patent Application Publication
(10) Pub. No.: US 2004/0126573 A1
(43) Pub. Date: Jul. 1, 2004

(54) Layered system and process for its preparation

(76) Inventors: Peter Bier, Krefeld (DE); Reiner Meyer, Moers (DE); Peter Capellen, Krefeld (DE)

Correspondence Address: BAYER POLYMERS LLC, 100 BAYER ROAD, PITTSBURGH, PA, 15205, US

(21) Appl. No.: 10/700,750

(22) Filed: Nov. 4, 2003

(30) Foreign Application Priority Data
Nov. 12, 2002 (DE) 10252421.1

(51) Int. Cl. B32B 5/16

(52) U.S. Cl. 428/328; 428/331

(57) ABSTRACT

A layered structure comprising in sequence a substrate, a scratch-resistant layer and a covering layer is disclosed. The scratch-resistant layer contains an at least partially cured polycondensate of a first reaction mixture that contains at least one silane, and the covering layer contains a cured polycondensate of a second reaction mixture that contains a silane compound having at least one non-hydrolyzable substituent that carries an epoxy group. The invention finds applicability for the uniform coating of three-dimensional substrates, especially motor vehicle windows.

### FIELD OF THE INVENTION

The present invention relates to a layered system and to a process for its preparation.

### SUMMARY OF THE INVENTION

A layered structure comprising in sequence a substrate, a scratch-resistant layer and a covering layer is disclosed. The scratch-resistant layer contains an at least partially cured polycondensate of a first reaction mixture that contains at least one silane, and the covering layer contains a cured polycondensate of a second reaction mixture that contains a silane compound having at least one non-hydrolyzable substituent that carries an epoxy group. The invention finds applicability for the uniform coating of three-dimensional substrates, especially motor vehicle windows.

### BACKGROUND OF THE INVENTION

With the aid of the sol-gel process it is possible, by targeted hydrolysis and condensation of alkoxides, predominantly of silicon, aluminium, titanium and zirconium, to produce inorganic-organic hybrid materials.

By means of that process, an inorganic network is built up. Organic groups may additionally be incorporated by way of appropriately derivatized silicic acid esters, which organic groups may be used on the one hand for functionalization and on the other hand form defined organic polymer systems. That material system offers a very broad variability on account of the many possible combinations of both the organic and the inorganic components and on account of the fact that the product properties may be influenced greatly by the preparation process. Coating systems in particular may be obtained thereby and tailored to a very wide variety of requirement profiles.

In comparison to pure inorganic materials, the resulting layers are still relatively soft. The reason is that, although the inorganic components in the system have a pronounced crosslinking action, they do not come to bear on the mechanical properties, such as, for example, hardness and abrasion resistance, because of their very small size. The advantageous mechanical properties of the inorganic components may be exploited fully by so-called filled polymers because particle sizes of several micrometres are present therein. However, the transparency of the materials is lost and applications in the field of optics are no longer possible. Although small particles having a size in the nanometre range of SiO₂ (e.g. Aerosils®), silica sol, Al₂O₃, boehmite, zirconium dioxide, titanium dioxide, etc. may be used to produce transparent layers having increased abrasion resistance, the levels of abrasion resistance that may be achieved are similar to those of the above-mentioned systems. The upper limit of the amount of filler is determined by the high surface reactivity of the small particles, which results in agglomerations or intolerable increases in viscosity.

From DE-A 199 52 040 there are known substrates having an abrasion-resistant diffusion barrier layer, the diffusion barrier layer comprising a hard base layer based on hydrolyzable epoxy silanes and a covering layer disposed over it. The covering layer is obtained by applying a coating sol of tetraethoxysilane (TEOS) and glycidyloxypropyltrimethoxysilane (GPTS) and curing it at a temperature <110° C. The coating sol is prepared by pre-hydrolysis of TEOS with ethanol as solvent in HCl-acidic aqueous solution and condensation. GPTS is then stirred into the TEOS so pre-hydrolysed and the sol is stirred for 5 hours at 50° C.

A disadvantage of the coating sol described in that specification is its poor storage stability (working life), as a result of which the coating sol must be processed further within a few days following its production. A further disadvantage of the diffusion barrier layer systems described in that specification is that they exhibit unsatisfactory results according to the Taber wear test for use in the glazing of motor vehicles. Finally, it is disadvantageous from the point of view of production economics that adhesion between the base layer and the covering layer is only ensured if the covering layer is applied and cured immediately, i.e. within a few hours, after curing of the base layer. There is no possibility of separating the operations of coating with the covering layer and application of the base layer. On the contrary, the substrates coated with the base layer must immediately be processed further without first being stored intermediately, as would often be desirable for reasons of process economy, and only being provided with the covering layer as required.

U.S. Pat. No. 4,842,941 discloses a plasma coating process in which a siloxane lacquer is applied to a substrate, the substrate so coated is introduced into a vacuum chamber, and the surface of the coated substrate is activated with oxygen plasma in vacuo. Following the activation, dry-chemical or physical coating with a silane is carried out under a high vacuum by means of the CVD (chemical vapor deposition) or PECVD (physical enhanced chemical vapor deposition) process. As a result, a highly scratch-resistant layer is formed on the substrate. Disadvantages of the described dry-chemical or physical coating process are the high investment required for a plasma coating installation, and the complex technical measures needed to produce and maintain the vacuum. In addition, the described plasma coating process is suitable to only a limited extent for coating three-dimensional bodies of large surface area.

The object underlying the present invention is to provide a scratch-resistant layered system and a process for the preparation of such a layered system, comprising a substrate (S), a scratch-resistant layer (K) and a highly scratch-resistant covering layer (DE), which system provides optimum adhesion between the scratch-resistant layer (K) and the covering layer (DE) and is suitable also for the uniform coating of three-dimensional substrates (S), especially motor vehicle windows. The process should also allow production of the scratch-resistant layer (K) and of the covering layer (DE) to be separated and should ensure that, once a scratch-resistant layer (K) has been produced, it may still be coated with the covering layer (DE) easily and without problems even after a storage time of several weeks or months. The layered system and the process should further provide a coating which has even further improved scratch resistance, adhesion, lacquer viscosity and elasticity and which exhibits a lower tendency to gelling and clouding as compared with the compositions of the prior art.

### DETAILED DESCRIPTION OF THE INVENTION

That object is achieved according to the invention by a layered system and a process for the preparation of a layered system such as is disclosed by present patent application.

Production of the Scratch-Resistant Layer (K)

The production of the scratch-resistant layer (K) is preferably carried out in step (a) by applying a coating composition to a substrate (S), wherein the coating composition comprises a polycondensation product which has been prepared by the sol-gel process and is based on at least one silane, and curing it at least partially. The production of such scratch-resistant layers (K) on a substrate (S) is known to the person skilled in the art.

The choice of substrate materials (S) for coating is not limited. There are suitable especially wood, textiles, paper, stoneware, metals, glass, ceramics and plastics, especially thermoplastics, as are described in Becker/Braun, Kunststofftaschenbuch, Carl Hanser Verlag, Munich, Vienna 1992. Transparent thermoplastics, and especially polycarbonates, are very particularly suitable. Injection-molded parts, films, spectacle lenses, optical lenses, motor vehicle windows and sheets in particular may be used according to the invention. The scratch-resistant layer (K) is preferably formed in a thickness of from 0.5 to 30 μm. A primer layer (P) may additionally be formed between the substrate (S) and the scratch-resistant layer (K).

Suitable coating compositions for the scratch-resistant layer (K) include any silane-based polycondensation products prepared by the sol-gel process. Particularly suitable coating compositions for the scratch-resistant layer (K) are especially

(1) methylsilane systems,

(2) silica-sol-modified methylsilane systems,

(3) silica-sol-modified silyl acrylate systems,

(4) silyl acrylate systems modified with other nanoparticles (especially boehmite) and

(5) cyclic organosiloxane systems.

The above-mentioned coating compositions for the scratch-resistant layer (K) are described in greater detail below:

(1) Methylsilane Systems

There may be used as coating compositions for the scratch-resistant layer (K), for example, known polycondensation products based on methylsilane. Polycondensation products based on methyltrialkoxysilanes are preferably used. Coating of the substrate (S) may be carried out, for example, by applying a mixture of at least one methyltrialkoxysilane, a water-containing organic solvent and an acid, evaporating off the solvent, and curing the silane under the effect of heat to form a highly crosslinked polysiloxane. The solution of the methyltrialkoxysilane preferably contains 60 to 80 wt. % silane. Methyltrialkoxysilanes that hydrolyze rapidly are especially suitable, which is the case especially when the alkoxy group contains not more than four carbon atoms. Suitable catalysts for the condensation reaction of the silanol groups formed by hydrolysis of the alkoxy groups of the methyltrialkoxysilane are ammonium compounds or, especially, strong inorganic acids, such as sulfuric acid and perchloric acid. The concentration of the acid catalyst is preferably about 0.15 wt. %, based on the silane. Especially suitable inorganic solvents for the system containing methyltrialkoxysilane, water and acid are alcohols, such as methanol, ethanol and isopropanol, or ether alcohols, such as ethyl glycol. The mixture preferably contains from 0.5 to 1 mol. of water per mol. of silane. The preparation, application and curing of such coating compositions are known to the person skilled in the art and described, for example, in specifications DE-A 2 136 001, DE-A 2 113 734 and U.S. Pat. No. 3,707,397 incorporated herein by reference.

(2) Silica-Sol-Modified Methylsilane Systems

Polycondensation products based on methylsilane and silica sol may also be used as coating compositions for the scratch-resistant layer (K). Particularly suitable coating compositions of that type are polycondensation products prepared by the sol-gel process and substantially comprising from 10 to 70 wt. % silica sol and from 30 to 90 wt. % of a partially condensed organoalkoxysilane in an aqueous/organic solvent mixture. Particularly suitable coating compositions are the heat-curable, primer-free silicone hard-coat compositions which are described in U.S. Pat. No. 5,503,935 incorporated by reference herein and comprise, based on the weight:

(A) 100 parts of resin solids in the form of a silicone dispersion in aqueous/organic solvents containing from 10 to 50 wt. % solids and substantially comprising from 10 to 70 wt. % colloidal silicon dioxide and from 30 to 90 wt. % of a partial condensation product of an organoalkoxysilane, and

(B) from 1 to 15 parts of an adhesion promoter selected from

(i) an acrylated polyurethane adhesion promoter having a \overline{M}ₙ of from 400 to 1500 and selected from an acrylated polyurethane and a methacrylated polyurethane, and

(ii) an acrylic copolymer having reactive or interactive sites and a \overline{M}ₙ of at least 1000.

Organoalkoxysilanes which maybe used in the preparation of the dispersion of the heat-curable, primer-free silicone hard-coat compositions in aqueous/organic solvents are preferably embraced by the formula

(R)ₐSi(OR¹)₄₋ₐ

wherein

R is a monovalent C₁₋₆-hydrocarbon radical, especially a C₁₋₄-alkyl radical,

R¹ is a radical R or a hydrogen radical, and

a is an integer from 0 up to and including 2.

The organoalkoxysilane of the above-mentioned formula is preferably methyltrimethoxysilane, methyltriethoxysilane or a mixture thereof which is capable of forming a partial condensation product.

The preparation, properties and curing of such heat-curable, primer-free silicon hard-coat compositions are known to the person skilled in the art and described in detail, for example, in U.S. Pat. No. 5,503,935.

As coating compositions for the scratch-resistant layer (K) there may also be used polycondensation products based on methylsilanes and silica sol having a solids content, dispersed in a water/alcohol mixture, of from 10 to 50 wt. %. The solids dispersed in the mixture include silica sol, especially in an amount of from 10 to 70 wt. %, and a partial condensation product derived from organotrialkoxysilanes, preferably in an amount of from 30 to 90 wt. %, the partial condensation product preferably having the formula

R′Si(OR)₃

wherein

R′is selected from the group consisting of alkyl radicals having from 1 to 3 carbon atoms and aryl radicals having from 6 to 13 carbon atoms, and

R is selected from the group consisting of alkyl radicals having from 1 to 8 carbon atoms and aryl radicals having from 6 to 20 carbon atoms.

The coating composition preferably has an alkaline pH value, especially a pH value of from 7.1 to about 7.8, which is achieved by means of a base which is volatile at the curing temperature of the coating composition.

The preparation, properties and curing of such coating compositions are known and are described, for example, in U.S. Pat. No. 4,624,870 incorporated herein by reference.

The coating compositions mentioned above and described in U.S. Pat. No. 4,624,870 are in most cases used in combination with a suitable primer, the primer forming an intermediate layer between the substrate (S) and the scratch-resistant layer (K). Suitable primer compositions are, for example, polyacrylate primers. Suitable polyacrylate primers are those based on polyacrylic acid, polyacrylic esters and copolymers of monomers having the general formula

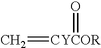

wherein

Y represents H, methyl or ethyl, and

R represents a C₁₋₁₂-alkyl group.

The polyacrylate resin may be thermoplastic or thermosetting and is preferably soluble in a solvent. There may be used as the acrylate resin solution, for example, a solution of polymethyl methacrylate (PMMA) in a solvent mixture of a rapidly evaporating solvent, such as propylene glycol methyl ether, and a more slowly evaporating solvent, such as diacetone alcohol. Particularly suitable acrylate primer solutions are thermoplastic primer compositions containing

(A) polyacrylic resin and

(B) from 90 to 99 parts by weight of an organic solvent mixture containing

(i) from 5 to 25 wt. % of a solvent having a boiling point of from 150 to 200° C. under normal conditions, in which (A) is readily soluble, and

(ii) from 75 to 95 wt. % of a solvent having a boiling point of from 90 to 150° C. under normal conditions, in which (A) is soluble.

The preparation, properties and drying of the last-mentioned thermoplastic primer compositions are known to the person skilled in the art and described, for example, in U.S. Pat. No. 5,041,313 incorporated herein by reference.

In addition to the above-mentioned constituents, the primer compositions may also contain conventional constituents, especially UV absorbers such as triazine, dibenzoyl resorcinol, benzophenone, benzotriazole, oxalanilide, malonic acid ester, cyanacrylate derivatives.

Nanoscale inorganic particles, such as cerium oxide, titanium dioxide, zinc oxide, have also proved suitable as UV absorbers.

As already mentioned, the primer layer is disposed between the substrate (S) and the scratch-resistant layer (K) and serves to promote adhesion between the two layers.

Further coating agents for the scratch-resistant layer (K) based on methylsilane and silica sol are described, for example, in EP-A 0 570 165, U.S. Pat. No. 4,278,804, U.S. Pat. No. 4,495,360, U.S. Pat. No. 4,624,870, U.S. Pat. No. 4,419,405, U.S. Pat. No. 4,374,674 and U.S. Pat. No. 4,525,426, all incorporated herein by reference.

(3) Silica-Sol-Modified Silyl Acrylate Systems

Polycondensation products based on silyl acrylate may also be used as coating compositions for the scratch-resistant layer (K). In addition to silyl acrylate, such coating compositions preferably contain colloidal silica (silica sol). Suitable silyl acrylates especially are acryloxy-functional silanes of the general formula

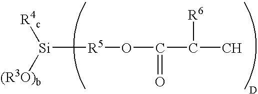

in which

R³ and R⁴ are identical or different monovalent hydrocarbon radicals,

R⁵ is a divalent hydrocarbon radical having from 2 to 8 carbon atoms,

R⁶ represents hydrogen or a monovalent hydrocarbon radical,

b is an integer having a value from 1 to 3,

c is an integer having a value from 0 to 2, and

D is an integer having a value of (4-b-c), or

glycidoxy-functional silanes of the general formula

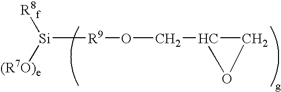

wherein

R⁷ and R⁸ are identical or different monovalent hydrocarbon radicals,

R⁹ represents a divalent hydrocarbon radical having from 2 to 8 carbon atoms,

e is an integer having a value from 1 to 3,

f is an integer having a value from 0 to 2, and

g is an integer having a value of (4-e-f),

and mixtures thereof.

The preparation and properties of such acryloxy-functional silanes and glycidoxy-functional silanes are known to the person skilled in the art and described, for example, in DE-A 3 126 662.

Particularly suitable acryloxy-functional silanes are, for example, 3-methacryloxypropyltrimethoxysilane, 3-acryloxypropyltrimethoxysilane, 2-methacryloxyethyltrimethoxysilane, 2-acryloxyethyltrimethoxysilane, 3-methacryloxypropyltriethoxysilane, 3-acryloxypropyltriethoxysilane, 2-methacryloxyethyltriethoxysilane and 2-acryloxyethyltriethoxysilane.

Particularly suitable glycidoxy-functional silanes are, for example, 3-glycidoxypropyltrimethoxysilane, 2-giycidoxyethyltrimethoxysilane, 3-glycidoxypropyltriethoxysilane and 2-glycidoxyethyltriethoxysilane. Those compounds are likewise described in DE-A 3 126 662.

Such coating compositions may contain further acrylate compounds, especially hydroxy acrylates, as a further constituent. Further acrylate compounds which may be used are, for example, 3-hydroxyethyl acrylate, 2-hydroxyethyl methacrylate, 3-hydroxypropyl acrylate, 3-hydroxypropyl methacrylate, 2-hydroxy-3-methacryloxypropyl acrylate, 2-hydroxy-3-acryloxypropyl acrylate, 2-hydroxy-3-methacryloxypropyl methacrylate, diethylene glycol diacrylate, triethylene glycol diacrylate, tetraethylene glycol diacrylate, trimethylolpropane triacrylate, tetrahydrofurfuryl methacrylate and 1,6-hexanediol diacrylate.

Particularly preferred coating compositions of that type are those which contain 100 parts by weight of colloidal silica, from 5 to 500 parts by weight of silyl acrylate and from 10 to 500 parts by weight of further acrylate.

In conjunction with a catalytic amount of a photoinitiator, such coating compositions, after application to a substrate (S), maybe cured by UV radiation with the formation of a scratch-resistant layer (K), as described in DE-A 3 126 662.

The coating compositions may also contain conventional additives. Also particularly suitable are the radiation-curable scratch-resistant coatings described in U.S. Pat. No. 5,990,188, incorporated herein by reference which, in addition to the above-mentioned constituents, also contain a UV absorber such as triazine or dibenzyl resorcinol derivatives.

Further coating compositions based on silyl acrylates and silica sol are described in U.S. Pat. No. 5,468,789, U.S. Pat. No. 5,466,491, U.S. Pat. No. 5,318,850, U.S. Pat. No. 5,242,719 and U.S. Pat. No. 4,455,205 all incorporated herein by reference.

(4) Silyl Acrylate Systems Modified with Other Nanoparticles

It is also possible to use as coating compositions silyl-acrylate-based polycondensation products that contain as a further constituent nanoscale AlO(OH) particles, especially nanoscale boehinite particles. Such coating compositions are described, for example, in WO 98/51747, WO 00/14149, DE-A 197 46 885, U.S. Pat. No. 5,716,697 and WO 98/04604 incorporated herein by reference.

By the addition of photoinitiators, such coating compositions, after application to a substrate (S), maybe cured by UV radiation with the formation of a scratch-resistant layer (K).

(5) Cyclic organosiloxane Systems

Polycondensation products based on multifunctional cyclic organosiloxanes may also be used as coating compositions for the scratch-resistant layer (K). Suitable such multifunctional cyclic organosiloxanes are especially those of the following formula (II)

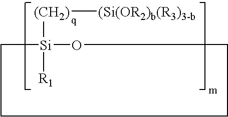

wherein

m is from 3 to 6, preferably 4,

q is from 2 to 10, preferably 2,

b is 1, 2 or 3, preferably 1 or 2,

R₁ represents C₁-C₆-alkyl or C₆-C₁₄-aryl, preferably methyl or ethyl,

R₂ represents hydrogen, alkyl or aryl when b is 1, or alkyl or aryl when b is 2 or 3, and

R₃ represents alkyl or aryl, preferably methyl.

Examples of compounds of formula (II) are:

cyclo-{OSiCH₃[(CH₂)₂Si(OH)(CH₃)₂]}₄,

cyclo-{OSiCH₃[(CH₂)₂Si(OCH₃)(CH₃)₂]}₄,

cyclo-{OSiCH₃[(CH₂)₂Si(OCH₃)₂(CH₃)]}₄,

cyclo-{OSiCH₃[(CH₂)₂Si(OC₂H₅)(CH₃)]}₄,

cyclo-{OSiCH₃[(CH₂)₂Si(OC₂H₅)₃]}₄

The preparation and properties of such multifunctional cyclic organosiloxanes and their use in scratch-resistant coating compositions are known to the person skilled in the art and described, for example, in DE-A 196 03 241. Further coating compositions based on cyclic organosiloxanes are described, for example, in WO 98/52992, DE-A 197 11 650, WO 98/25274 and WO 98/38251.

In order to adjust the rheological properties of the compositions for the scratch-resistant layer, inert solvents or solvent mixtures may optionally be added at any desired stage of the preparation, especially during the hydrolysis. Such solvents are preferably alcohols that are liquid at room temperature and that are otherwise also formed during the hydrolysis of the alkoxides preferably used. Particularly preferred alcohols are C₁₋₈ alcohols, especially methanol, ethanol, n-propanol, isopropanol, n-butanol, isobutanol, tert.-butanol, n-pentanol, isopentanol, h-hexanol, n-octanol and n-butoxyethanol. Also preferred are C₁₋₆-glycol ethers, especially n-butoxyethanol. Isopropanol, butanol, ethanol and/or water are particularly suitable as solvents.

The compositions may also contain conventional additives, such as, for example, colorants, flow improvers, UV stabilizers, IR stabilizers, photoinitiators, photosensitisers (if photochemical curing of the composition is intended) and/or thermal polymerization catalysts. Flow improvers are especially those based on polyether-modified polydimethylsiloxanes. It has proved particularly advantageous if the compositions contain flow improvers in an amount of approximately from 0.01 to 3 wt. %.

The coating composition so prepared may be used to coat different substrates. The choice of substrate materials for coating is not limited. The compositions are suitable preferably for coating wood, textiles, paper, stoneware, metals, glass, ceramics and plastics, especially for coating thermoplastics, such as are described in Becker/Braun, Kunststofftaschenbuch, Carl Hanser Verlag, Munich, Vienna 1992. The compositions are very especially suitable for coating transparent thermoplastics and preferably polycarbonates. Injection-molded parts, films, spectacle lenses, optical lenses, motor vehicle windows and sheets in particular maybe coated with the compositions obtained according to the invention.

Application to the substrate is preferably carried out by standard coating processes such as, for example, immersion, pouring, spread coating, brushing, knife application, roller coating, spraying, falling film application, spin coating and centrifugation.

It is possible for the coating composition to be only partially dried on the substrate, or curing of the coated substrate is carried out at room temperature, optionally after previous partial drying. Curing is preferably carried out at temperatures in the range of from >20 to 200° C., especially from 70 to 180° C. and particularly preferably from 90 to 150° C. The curing time under those conditions is 15 to 200 minutes, preferably 45 to 120 minutes. The layer thickness of the cured scratch-resistant layer (K) should be from 0.5 to 30 μm, preferably from 1 to 20 μm and especially from 2 to 10 μm.

If unsaturated compounds and/or epoxy compounds are present, curing may also be effected by irradiation, optionally followed by thermal post-curing.

Production of the Covering Layer (DE)

The coating compositions according to the invention are suitable especially for the production of covering layers (DE) in scratch-resistant coating systems. Especially suitable for the application to scratch-resistant layers (K) are covering layers (DE) based on hydrolysable silanes having epoxy groups.

Preferred covering layers (DE) are those which are obtainable by curing of a coating composition containing a polycondensation product, prepared by the sol-gel process, which is based on at least one silane and has an epoxy group on a non-hydrolysable substituent, and optionally a curing catalyst selected from Lewis bases and alcoholates of titanium, zirconium or aluminium. The production and properties of such covering layers (DE) are described, for example, in DE-A 43 38 361.

Covering layers (DE) are preferably those which have been produced from a coating composition containing

a silicon compound (A) having at least one radical which is not cleavable by hydrolysis, is bonded directly to Si and contains an epoxy group,

particulate materials (B),

a hydrolyzable compound (C) of Si, Ti, Zr, B, Sn or V, and preferably in addition

a hydrolyzable compound (D) of Ti, Zr or Al.

Such coating compositions yield highly scratch-resistant coatings which adhere to the material particularly well.

Compounds (A) to (D) are described in greater detail below.

Silicon compound (A)

The silicon compound (A) is preferably a silicon compound which has 2 or 3, preferably 3, hydrolysable radicals and one or 2, preferably one, non-hydrolysable radical. The single non-hydrolysable radical, or at least one of the two non-hydrolysable radicals, has an epoxy group.

Examples of hydrolyzable radicals are halogen (F, Cl, Br and I, especially Cl and Br), alkoxy (especially C₁₋₄-alkoxy, such as, for example, methoxy, ethoxy, n-propoxy, isopropoxy and n-butoxy, isobutoxy, sec.-butoxy and tert.-butoxy), aryloxy (especially C₆₋₁₀-aryloxy, for example phenoxy), acyloxy (especially C₁₋₄-acyloxy, such as, for example, acetoxy and propionyloxy) and acylcarbonyl (e.g. acetyl). Particularly preferred hydrolyzable radicals are alkoxy groups, especially methoxy and ethoxy.

Examples of non-hydrolyzable radicals without an epoxy group are hydrogen, alkyl, especially C₁₋₄-alkyl (such as, for example, methyl, ethyl, propyl and butyl), alkenyl (especially C₂₋₄-alkenyl, such as, for example, vinyl, 1-propenyl, 2-propenyl and butenyl), alkynyl (especially C₂₋₄-alkynyl, such as, for example, acetylenyl and propargyl) and aryl (especially C₆₋₁₀-aryl, such as, for example, phenyl and naphthyl), the groups just mentioned optionally containing one or more substituents, such as, for example, halogen and alkoxy. Methacryl- and methacryloxy-propyl radicals may also be mentioned in this connection.

Examples of non-hydrolyzable radicals having an epoxy group are especially those which have a glycidyl or glycidyloxy group.

Examples of silicon compounds (A) which may be used according to the invention are disclosed to be found, for example, on pages 8 and 9 of EP-A 0 195 493 (corresponding to U.S. Pat. No. 4,895,767 incorporated by reference herein)

Silicon compounds (A) which are particularly preferred according to the invention are those of the general formula

R₃SiR′

in which the radicals R are identical or different (preferably identical) and represent a hydrolysable group (preferably C₁₋₄-alkoxy and especially methoxy and ethoxy) and R′ represents a glycidyl- or glycidyloxy-(C₁₋₂₀)-alkylene radical, especially β-glycidyloxyethyl, γ-glycidyloxypropyl, δ-glycidyloxybutyl, ε-glycidyloxypentyl, ω-glycidyloxyhexyl, ω-glycidyloxyoctyl, ω-glycidyloxynonyl, ω-glycidyloxydecyl, ω-glycidyloxydodecyl and 2-(3,4-epoxycyclohexyl)-ethyl.

Because of its ready availability, particular preference is given according to the invention to the use of γ-glycidyloxy-propyltrimethoxysilane (abbreviated to GPTS hereinbelow).

Particulate Materials (B)

The particulate materials (B) are preferably an oxide, oxide hydrate, nitride or carbide of Si, Al and B as well as of transition metals, preferably Ti, Zr and Ce, having a particle size in the range of from 1 to 100 nm, preferably from 2 to 50 nm and particularly preferably from 5 to 20 nm, and mixtures thereof. Such materials may be used in the form of a powder, but are preferably used in the form of a sol (especially an acid-stabilized sol). Preferred particulate materials are boehmite, SiO₂, CeO₂, ZnO, In₂O₃ and TiO₂. Particular preference is given to nanoscale boehmite particles. The particulate materials are commercially available in the form of powders, and the preparation of (acid-stabilized) sols therefrom is likewise known in the art. In addition, reference may be made to the Preparation Examples given below. The principle of the stabilization of nanoscale titanium nitride by means of guanidinepropionic acid is described, for example, in DE-A 43 34 639.

Particular preference is given to the use of boehmite sol having a pH in the range of from 2.5 to 3.5, preferably from 2.8 to 3.2, which may be obtained, for example, by suspending boehmite powder in dilute HCl.

The variation of the nanoscale particles is generally accompanied by a variation in the refractive index of the corresponding materials. For example, replacing the boehmite particles by CeO₂, ZrO₂ or TiO₂ particles leads to materials having higher refractive indices, the refractive index resulting according to the Lorentz-Lorenz equation additively from the volume of the highly refractive component and the matrix.

As mentioned, cerium dioxide may be used as the particulate material. It preferably has a particle size in the range of from 1 to 100 nm, preferably from 2 to 50 nm and particularly preferably from 5 to 20 nm. The material may be employed in the form of a powder but is preferably used in the form of a sol (especially an acid-stabilized sol). Particulate cerium oxide is commercially available in the form of sols and powders, and the preparation of (acid-stabilized) sols therefrom is likewise known in the art.

In the composition for the covering layer (D), compound (B) is preferably used in an amount of from 0.2 to 1.2 mol., based on 1 mol. of silicon compound (A).

Hydrolyzable Compounds (C)

In addition to the silicon compounds (A), other hydrolyzable compounds of elements from the group Si, Ti, Zr, Al, B, Sn and V are also used to prepare the coating composition for the scratch-resistant layer and are preferably hydrolyzed with the silicon compound(s) (A).

Compound (C) is a compound of Si, Ti, Zr, B, Sn and V of the general formula I

RₓM⁺⁴R′₄₋ₓ or

RₓM⁺³R′₃₋ₓ

wherein

M represents

a) Si⁺⁴, Ti⁺⁴, Zr⁺⁴, Sn⁺⁴, or

b) Al⁺³, B⁺³ or (VO)⁺³,

R represents a hydrolyzable radical,

R′ represents a non-hydrolyzable radical, and

X may be from 1 to 4 in the case of tetravalent metal atoms M (case a)) and from 1 to 3 in the case of trivalent metal atoms M (case b)).

If a plurality of radicals R and/or R′ are present in a compound (C), they may be identical or different. x is preferably greater than 1. That is to say, the compound (C) has at least one, preferably more than one, hydrolyzable radical.

Examples of hydrolyzable radicals are halogen (F, Cl, Br and I, especially Cl and Br), alkoxy (especially C₁₋₄-alkoxy, such as, for example, methoxy, ethoxy, n-propoxy, isopropoxy and n-butoxy, isobutoxy, sec.-butoxy or tert.-butoxy), aryloxy (especially C₆₋₁₀-aryloxy, for example phenoxy), acyloxy (especially C₁₋₄-acyloxy, such as, for example, acetoxy and propionyloxy) and alkylcarbonyl (e.g. acetyl). Particularly preferred hydrolyzable radicals are alkoxy groups, especially methoxy and ethoxy.

Examples of non-hydrolyzable radicals are hydrogen, alkyl, especially C₁₋₄-alkyl (such as, for example, methyl, ethyl, propyl and n-butyl, isobutyl, sec.-butyl and tert.-butyl), alkenyl (especially C₂₋₄-alkenyl, such as, for example, vinyl, 1-propenyl, 2-propenyl and butenyl), alkynyl (especially C₂₋₄-alkynyl, such as, for example, acetylenyl and propargyl) and aryl (especially C₆₋₁₀-aryl, such as, for example, phenyl and naphthyl), the groups just mentioned optionally containing one or more substituents, such as, for example, halogen and alkoxy. Methacryl- and methacryloxy-propyl radicals may also be mentioned in this connection.

In addition to those mentioned at the beginning as examples of compounds of formula I contained in the composition for the covering layer, the following preferred examples of compounds (C) may be mentioned:

CH₃—SiCl₃, CH₃—Si(OC₂H₅)₃, C₂H₅-SiCl₃, C₂H₅—Si(OC₂H₅)₃, C₃H₇—Si(OCH₃)₃, C₆H₅—Si(OCH₃)₃, C₆H₅—Si(OC₂H₅)₃, (CH₃)₃—S₁—C₃H₆—Cl, (CH₃)₂SiCl₂, (CH₃)₂Si(OCH₃)₂Si(OCH₃)₂, (CH₃)₂Si(OC₂H₅)₂, (CH₃)₂Si(OH)₂, (C₆H₅)₂SiCl₂, (C₆H₅)₂Si(OCH₃)₂, (C₆H₅)₂Si(OC₂H₅)₂, (i-C₃H₇)₃SiOH, CH₂═CH—Si(OOCCH₃)₃, CH₂═CH—SiCl₃, CH₂═CH—Si(OCH₃)₃, CH₂═CH—Si(OC₂H₅)₃, CH₂═CH—Si(OC₂H₄OCH₃)₃, CH₂═CH—CH₂—Si(OCH₃)₃, CH₂═CH—CH₂—Si(OC₂H₅)₃, CH₂═CH—CH₂—Si(OOCCH₃)₃, CH₂═C(CH₃)—COO—C₃H₇—Si(OCH₃)₃, CH₂═C(CH₃)—COO—C₃H₇—Si(OC₂H₅)₃.

Particular preference is given to the use of compounds of the type SiR₄, wherein the radicals R may be identical or different and represent a hydrolyzable group, preferably an alkoxy group having from 1 to 4 carbon atoms, especially methoxy, ethoxy, n-propoxy, isopropoxy, n-butoxy, isobutoxy, sec.-butoxy or tert.-butoxy. As is clear, those compounds (C), especially the silicon compounds, may also have non-hydrolyzable radicals which contain a C—C double bond or a C—C triple bond. If such compounds are used together with (or even instead of) the silicon compounds (A), it is additionally possible for monomers (preferably monomers containing epoxy groups or hydroxyl groups), such as, for example, meth(acrylates), to be incorporated into the composition (of course, such monomers may also have two or more functional groups of the same type, such as, for example, poly(meth)acrylates, polysiloxanes etc. of organic polyols; the use of organic polyepoxides is likewise possible). During the thermal or photochemically induced curing of the corresponding composition, polymerization of the organic species takes place in addition to the formation of the organically modified inorganic matrix, as a result of which the crosslinking density and hence also the hardness of the corresponding coatings and molded articles increases.

In the composition for the covering layer (DE), compound (C) is preferably used in an amount of from 0.2 to 1.2 mol., based on 1 mol. of silicon compound (A).

Hydrolysable Compound (D)

The hydrolysable compound (D) is preferably a compound of Ti, Zr or Al of the following general formula

M(R′″)ₙ

wherein

M represents Ti, Zr or Al, and

the radicals R′″ may be identical or different and represent a hydrolyzable group, and

n is equal to 4 (M=Ti, Zr) or equal to 3 (M=Al).

Examples of hydrolyzable groups are halogen (F, Cl, Br and I, especially Cl and Br), alkoxy (especially C₁₋₆-alkoxy, such as, for example, methoxy, ethoxy, n-propoxy, isopropoxy and n-butoxy, isobutoxy, sec.-butoxy or tert.-butoxy, n-pentyloxy, n-hexyloxy), aryloxy (especially C₆₋₁₀-aryloxy, for example phenoxy), acyloxy (especially C₁₋₄-acyloxy, such as, for example, acetoxy and propionyloxy) and alkylcarbonyl (e.g. acetyl), or a C₁₋₆-alkoxy-C₂₋₃-alkyl group, i.e. a group derived from C₁₋₆-alkyl ethylene glycol or propylene glycol, wherein alkoxy has the same meaning as mentioned above.

M is particularly preferably aluminium, and R′″ is particularly preferably ethoxy, sec.-butoxy, n-propoxy, n-butoxy-, n-propoxy-, 2-propoxy-, ethoxy- and/or methoxy-ethoxy.

In the composition for the covering layer (DE), the compound (D) is preferably used in an amount of from 0.1 to 0.7 mol., based on 1 mol. of silicon compound (A).

In order to achieve a more hydrophilic nature of the coating composition for the scratch-resistant layer, a Lewis base (E) may additionally be used as catalyst.

It is also possible additionally to use a hydrolyzable silicon compound (F) having at least one non-hydrolyzable radical which contains from 5 to 30 fluorine atoms bonded directly to carbon atoms, wherein the carbon atoms are separated from Si by at least two atoms. By the use of such a fluorinated silane, hydrophobic and dirt-repelling properties are additionally imparted to the corresponding coating.

The preparation of the compositions for the covering layer (DE) may be carried out by the process described in greater detail hereinbelow, in which a sol of the material (B) having a pH in the range of from 2.0 to 6.5, preferably from 2.5 to 4.0, is reacted with a mixture of the other components.

Even more preferably, they are prepared by a process, which is likewise defined hereinbelow, in which the sol as defined above is added in two portions to the mixture of (A) and (C), wherein particular temperatures are preferably maintained, and wherein the addition of (D) is carried out between the two portions of (B), also preferably at a particular temperature.

The hydrolysable silicon compound (A) may optionally be pre-hydrolyzed in aqueous solution together with the compound (C) using an acid catalyst (preferably at room temperature), there being used preferably about ½ mol. of water per mol. of hydrolyzable group. Hydrochloric acid is preferably used as the catalyst for the pre-hydrolysis.

The particulate materials (B) are preferably suspended in water and the pH adjusted to from 2.0 to 6.5, preferably from 2.5 to 4.0. Hydrochloric acid is preferably used for the acidification. If boehmite is used as the particulate material (B), it forms a clear sol under those conditions.

The compound (C) is mixed with the compound (A). The first portion of the particulate material (B) suspended as described above is then added. The amount is preferably so chosen that the water contained therein is sufficient for the semi-stoichiometric hydrolysis of the compounds (A) and (C). It is from 10 to 70 wt. % of the total amount, preferably from 20 to 50 wt. %.

The reaction is slightly exothermic. When the first exothermic reaction has subsided, the temperature is adjusted to approximately from 28 to 35° C., preferably approximately from 30 to 32° C., until the reaction starts and an internal temperature is reached that is higher than 25° C., preferably higher than 30° C. and more preferably higher than 35° C. When the addition of the first portion of the material (B) is complete, the temperature is maintained for from 0.5 to 3 hours, preferably from 1.5 to 2.5 hours, and cooling to about 0° C. is then carried out. The remaining material (B) is added slowly preferably at a temperature of 0° C. The compound (D) and, optionally, the Lewis base (E), also preferably after the addition of the first portion of the material (D), are then added slowly at about 0° C. Before the addition of the second portion of the material (B), the temperature is then maintained at about 0° C. for from 0.5 to 3 hours, preferably for from 1.5 to 2.5 hours. The remainder of the material (B) is then added slowly at a temperature of about 0° C. The solution added dropwise is preferably pre-cooled to about 10° C. immediately before it is added to the reactor.

After the slow addition of the second portion of the compound (B) at about 0° C., the cooling is preferably removed so that warming of the reaction mixture to a temperature of more than 15° C. (to room temperature) takes place slowly without additional temperature adjustment.

In order to adjust the rheological properties of the compositions for the covering layer, solvents or solvent mixtures may optionally be added at any desired stage of the preparation. Such solvents are preferably the solvents already described at the beginning for the composition for the scratch-resistant layer. Preferred solvents are water, alkoxy alcohols and/or alcohols, especially water.

The compositions for the covering layer may contain the conventional additives already described at the beginning for the composition for the scratch-resistant layer.

The application and curing of the covering layer composition, after partial drying, takes place preferably thermally at from 50 to 200° C., preferably from 70 to 180° C. and especially from 110 to 130° C. The curing time under those conditions should be less than 240 minutes, preferably less than 180 minutes, especially less than 120 minutes.

When additional photoinitiators are used, curing may also take place by irradiation, which is optionally followed by thermal curing.

The layer thickness of the cured covering layer (DE) should be from 0.1 to 30 μm, preferably from 0.5 to 10 μm and especially from 1.0 to 6 μm.

Accordingly, the invention also includes a layered system containing

(a) a substrate (S),

(b) optionally a primer layer,

(c) a scratch-resistant layer (K), as described above, and.

(d) a covering layer (DE) formed from the composition prepared by the process according to the invention.

Application to the substrate is preferably carried out by standard coating methods such as, for example, immersion, pouring, spread coating, brushing, knife application, roller coating, spraying, falling film application, spin coating and centrifugation.

The layered systems according to the invention maybe prepared by a process which comprises at least the following steps:

(a) application of the coating composition for the scratch-resistant layer to the optionally primed substrate (S), and partial drying or additional partial curing or polymerization of the coating composition under conditions such that reactive groups are still present to a greater or lesser extent,

(b) application of the coating composition according to the invention for the covering layer to the scratch-resistant layer (K) so produced and curing thereof with formation of a covering layer (DE).

It has proved particularly advantageous when preparing the layered systems for the scratch-resistant layer (K) to be only partly dried after application or to be additionally dried thermally at temperatures in the range of from >20 to 200° C., especially from 70 to 180° C. and particularly preferably from 90 to 150° C. The curing time under those conditions should be from 15 to 200 minutes, preferably from 45 to 120 minutes. The layer thickness of the cured scratch-resistant layer (K) should be from 0.5 to 30 μm, preferably from 1 to 20 μm and especially from 2 to 10 μm.

If unsaturated compounds are present, curing may also be carried out by irradiation, which is optionally followed by thermal after-curing.

It is also advantageous if the coating composition for the scratch-resistant layer contains flow improvers in an amount of from 0.01 to 3 wt. %.

Finally, it has proved advantageous if the partially cured or, especially, fully cured scratch-resistant layer (K) is activated before application of the coating composition for the covering layer. Suitable activating processes are preferably corona treatment, flaming, plasma treatment or chemical etching. Flaming, normal-pressure plasma and corona treatment are particularly suitable. With regard to the advantageous properties, reference is made to the Implementation Examples.

The process for applying and curing the covering layer (DE) has already been described above.

The invention is explained further hereinbelow with reference to Implementation Examples.

### EXAMPLES

Preparation of the Coating Compositions for the Scratch-Resistant Layer (K)

### Example 1

203 g of methyltrimethoxysilane were mixed with 1.25 g of glacial acetic acid. 125.5 g of Ludox® AS (ammonium-stabilized colloidal silica sol from DuPont, 40% SiO₂ having a silicate particle diameter of about 22 nm and a pH value of 9.2) were diluted with 41.5 g of deionised water in order to adjust the SiO₂ content to 30 wt. %. That material was added to the acidified methyltrimethoxysilane, with stirring. The solution was stirred for a further 16 to 18 hours at room temperature and then added to a solvent mixture of isopropanol/n-butanol in a ratio by weight of 1:1. Finally, 32 g of the UV absorber 4-[γ-(tri-(methoxy/ethoxy)-silyl)propoxy]-2-hydroxybenzophenone were added. The mixture was stirred for two weeks at room temperature. The composition had a solids content of 20 wt. % and contained 11 wt. % of the UV absorber, based on the solid constituents. The coating composition had a viscosity of about 5 cSt at room temperature.

In order to accelerate the polycondensation reaction, 0.2 wt. % tetrabutylammonium acetate were mixed in homogeneously prior to application.

### Example 2 (primer)

3.0 parts of polymethyl methacrylate (Elvacite® 2041 from DuPont) were mixed with 15 parts of diacetone alcohol and 85 parts of propylene glycol monomethyl ether and stirred for two hours at 70° C. until dissolution was complete.

### Example 3

0.4 wt. % of a silicone flow improver and 0.3 wt. % of an acrylate polyol, namely Joncryl 587 (Mₙ 4300) from S. C. Johnson Wax Company, Racine, Wis. were stirred into the coating sol prepared according to Example 4. In order to accelerate the polycondensatin reaction, 0.2 wt. % of tetra-n-butylammonium acetate were mixed in homogeneously prior to application, as in Example 4.

Preparation of the Coating Compositions for the Covering Layer (DE)

### Example 4

354.5 g (3.0 mol.) of n-butoxyethanol were added dropwise, with stirring to 246.3 g (1.0 mol.) of aluminium tri-sec.-butanolate, whereupon the temperature rose to about 45° C. After cooling, the aluminate solution must be stored in a closed vessel.

1239 g of 0.1N HCl were placed in a reaction vessel. 123.9 g (1.92 mol.) of boehmite Dispersal Sol P3® from Condea, Hamburg were added, with stirring. Stirring was then carried out for one hour at room temperature. The solution was filtered through a deep-bed filter in order to remove solid impurities.

787.8 g (3.33 mol.) of GPTS (γ-glycidyloxypropyltrimethoxysilane) and 608.3 g of TEOS (tetraethoxysilane) (2.92 mol.) were mixed and stirred for 10 minutes. 214.6 g of the boehmite sol were added to that mixture in the course of about 2 minutes. A few minutes after the addition, the sol warmed to about 28 to 30° C. and was clear even after about 20 minutes. The mixture was then stirred for about 2 hours at 35° C. and then cooled to about 0° C.

At 0° C.±2° C., 600.8 g of the Al(OetOBu)₃ solution in sec.-butanol, prepared as described above and containing 1.0 mol. of Al(OetOBu)₃, were added. When the addition was complete, stirring was carried out for 2 hours at about 0° C., and the remaining boehmite sol was then likewise added at 0° C. ±2° C. Warming of the resulting reaction mixture to room temperature then took place in about 3 hours, without temperature adjustment. Byk 306® from BYK Chemie, Wesel was added as flow improver. The mixture was filtered and the resulting lacquer was stored at +4° C.

### Example 5

GPTS and TEOS were placed in a reaction vessel and mixed. The amount of boehmite dispersion (prepared analogously to Example 1) necessary for semi-stoichiometric pre-hydrolysis of the silanes was added slowly, with stirring. The reaction mixture was then stirred for 2 hours at room temperature. The solution was then cooled to 0° C. with the aid of a thermostat. Aluminium tributoxy-ethanolate was then added dropwise by means of a dropping funnel. After addition of the aluminate, stirring was carried out for a further one hour at 0° C. The remainder of the boehmite dispersion was then added, with cooling by means of a thermostat. After 15 minutes' stirring at room temperature, the cerium dioxide dispersion from Rhodia GmbH, Frankfurt/Main and BYK 306® as flow improver were added.

Amounts Used:

| | |
|---|---|
| TEOS | 62.50 g (0.3 mol.) |
| DMDMS | — |
| GPTS | 263.34 g (1 mol.) |
| Boehmite | 5.53 g (2 wt. %, based on total solids) |
| 0.1 n hydrochloric acid | 59.18 g |
| Cerium dioxide dispersion | 257.14 g (20 wt. %, based on total solids) |
| (20 wt. % in 2.5 wt. % | |
| acetic acid) | |
| Boehmite dispersion for | 41.38 g |
| semi-stoichiometric | |
| pre-hydrolysis | |
| Aluminium | 113.57 g (0.3 mol.) |
| tributoxyethanolate | |

### Example 6

149.44 g (1.964 mol.) of ethylene glycol monomethyl ether were added, with stirring, to 161.26 g (0.655 mol.) of aluminium tri-sec.-butylate, whereupon the temperature rose to about 45° C. The batch was then boiled at reflux for 4 hours at about 100-105° C. After cooling, the aluminate solution must be stored in a closed vessel.

1239 g of 0.1N HCl were placed in a reaction vessel. 123.9 g (1.92 mol.) of boehmite Dispersal P3® were added, with stirring. Stirring was then carried out for one hour at room temperature. The solution was filtered through a deep-bed filter in order to remove solid impurities.

452.7 g (1.91 mol.) of GPTS (3-glycidyloxypropyltrimethoxysilane) and 348.7 g (1.97 mol.) of TEOS (tetraethoxysilane) were placed in a reaction vessel and stirred for 2 minutes. 112 g of the boehmite sol were added to that mixture in the course of about one minute. A few minutes after the addition, the sol warmed to about 28-30° C. and was clear within about 20 minutes. The mixture was then stirred for 2 hours at 39° C. and then cooled to 0° C. At 0° C.±1° C., 310.7 g of the Al(OetOMe)₃ solution in sec.-butanol, prepared as described above, i.e. 0.655 mol. of A1(OetOMe)₃, were added (duration of metering at least 30 minutes). When the addition was complete, stirring was carried out for a further two hours at 0° C., and then the remaining boehmite sol was added likewise at 0° C.±1° C. (duration of metering at least one hour). The resulting reaction mixture was then slowly heated to room temperature in the course of 30 minutes. Byk 348® was added as flow improver. The mixture was filtered and the resulting coating composition was stored at 0° C. in a refrigerator.

Preparation of the Scratch-Resistant Coating Systems

Test specimens were prepared as follows using the resulting coating compositions:

Sheets of polycarbonate based on bisphenol A (Tg=147° C., M_{w} 27,500) measuring 105×150×4 mm were cleaned with isopropanol and optionally primed by having a primer solution poured over them. The primer solution (Example 2) is only partially dried.

The coating composition for the base coat (Example 1 or 3) was then poured over the primed polycarbonate sheets (Variant A). The period of exposure to the air for dust-drying was 30 minutes at 23° C. and 63% relative humidity. The dust-dry sheets were heated in an oven at 130° C. for 30 minutes and then. cooled to room temperature.

The coating composition for the covering layer (Example 4, 5 or 6) was then applied after diluting with water/i-propanol, likewise by pouring. The wet film was exposed to the air for 30 minutes at 23° C. and the sheets were then heated for 120 minutes at 130° C.:

In a further variant (B), the sheets, over which the scratch-resistant coating compositions of Example 1, 2 and 3 have been poured, are exposed to the air for one hour at 21° C. and 39% relative humidity for the purposes of dust-drying, and the dust-dry sheets are coated directly with the diluted coating composition for the covering layer of Example 6, likewise by pouring (wet-on-wet process). The wet film was exposed to the air for 30 minutes at 21° C. and 39% humidity and the sheets were then heated for 120 minutes at 130° C.

If the primer-free scratch-resistant lacquer is used, the primer step is omitted. In that case, the coating composition of Example 3 is poured over the polycarbonate sheets directly after they have been cleaned with isopropanol. The conditions are otherwise analogous.

Surface activation of the cured base coat layer by flaming, corona or normal-pressure plasma treatment, brushing or chemical etching, etc. has proved particularly advantageous for improving the adhesion and the flow of the coating composition for the covering layer.

After curing, the coated sheets were stored for two days at room temperature and then subjected to the following defined tests.

The properties of the coatings obtained using those lacquers were determined as follows:

cross-cut test: EN ISO 2409:1994

cross-cut test after storage in water: 65° C. The lacquered sheets are provided with a cross-cut according to EN ISO 2409:1994 and stored in hot water at 65° C. The storage time (days) from which the first loss of adhesion in the tape test from 0 to 2 occurs is recorded.

Taber abrasion test: wear test DIN 52 347; (1000 cycles, CS10F, 500 g).

The results of the assessment are shown in the following Tables:

Table 1 Variation of the Scratch-Resistant Layer (K)

Table 1 shows the application parameters, the wear (Taber values) and adhesion properties on storage of the layered systems in water, in dependence on the scratch-resistant layer (K) with and without a covering layer.

TABLE 1

| | | | | | | | | Taber | Cross-cut |
|---|---|---|---|---|---|---|---|---|---|
| | | | | | | | | abrasion | test after |
| | | | Scratch- | Application of | | Application of | | test | storage in |
| Example | | Application of | resistant | the scratch- | Covering | the covering | Visual | Clouding | water |
| No. | Primer | the primer | lacquer | resistant lacquer | lacquer | lacquer | impression | (%) | (days) |
| 7 | Example 2 | 0.5 h | Example 1 | 1.0 h vaporisation | Example 6 | 0.5 h | acceptable | 4.3 | >14 days |
| | | vaporisation | | | (solids 13 | vaporisation | | | |
| | | | | | wt. %) | 2.0 h curing at | | | |
| | | | | | | 130° C. | | | |
| 8 | none | none | Example 3 | 1.0 h vaporisation | Example 6 | 0.5 h | acceptable | 6.5 | >14 days |
| | | | | | (solids 13 | vaporisation | | | |
| | | | | | wt. %) | 2.0 h curing at | | | |
| | | | | | | 130° C. | | | |
| 9 | Example 2 | 0.5 h | Example 1 | 1.0 h vaporisation | Example 6 | 0.5 h | acceptable | 3.4 | >14 days |
| | | vaporisation | | | (solids 12 | vaporisation | | | |
| | | | | | wt. %) | 2.0 h curing at | | | |
| | | | | | | 130° C. | | | |
| 10 | Example 2 | 0.5 h | Example 1 | 1.0 h vaporisation | Example 6 | 0.5 h | acceptable | 4.8 | >14 days |
| | | vaporisation | | | (solids 14 | vaporisation | | | |
| | | | | | wt. %) | 2.0 h curing at | | | |
| | | | | | | 130° C. | | | |

Table 2 (Variation of the Covering Layer (DE))

Table 2 shows the wear properties (Taber values) in dependence on the scratch-resistant layer (K), the lacquer application, the activation method and the covering layer (D).

All the layered systems exhibit good adhesion properties at the beginning and also after 14 days' storage in water.

Table 3

Table 3 shows the wear properties of commercially available polycarbonate sheets with a scratch-resistant finish, which sheets, after activation by flaming or corona treatment, have been provided with the covering lacquer according to the invention. Without activation, there is no adhesion of the covering lacquer. The Taber value of the Lexan-Margard® M5E sheet used without a covering lacquer was 15.1%.

TABLE 2

| | | | | Application of | | | | Taber |
|---|---|---|---|---|---|---|---|---|
| | | | Scratch- | the scratch- | | | Application of | abrasion test |
| Example | | Application of | resistant | resistant | | Covering | the covering | Clouding |
| No. | Primer | the primer | lacquer | lacquer | Activation | lacquer | lacquer | (%) |
| 11 | Example | 0.5 h | Example | 0.5 h | 2 × flaming | Example 6 | 0.5 h | 3.8 |
| | 2 | vaporisation | 1 | vaporisation | Rate of | (solids 13 | vaporisation | |
| | | | | 1.0 h curing at | passage 3 | wt. %) | 2.0 h curing at | |
| | | | | 130° C. | m/min | | 130° C. | |
| 12 | Example | 0.5 h | Example | 0.5 h | 2 × flaming | Example 4 | 0.5 h | 4.2 |
| | 2 | vaporisation | 1 | vaporisation | Rate of | (solids 12 | vaporisation | |
| | | | | 1.0 h curing at | passage 3 | wt. %) | 2.0 h curing at | |
| | | | | 130° C. | m/min | | 130° C. | |
| 13 | Example | 0.5 h | Example | 0.5 h | 2 × flaming | Example 5 | 0.5 h | 4.8 |
| | 2 | vaporisation | 1 | vaporisation | Rate of | (solids 13 | vaporisation | |
| | | | | 1.0 h curing at | passage 3 | wt. %) | 2.0 h curing at | |
| | | | | 130° C. | m/min | | 130° C. | |
| 14 | none | none | Example | 0.5 h | 2 × flaming | Example 4 | 0.5 h | 5.4 |
| | | | 1 | vaporisation | Rate of | (solids 12 | vaporisation | |
| | | | | 1.0 h curing at | passage 3 | wt %) | 2.0 h curing at | |
| | | | | 130° C. | m/min | | 130° C. | |
| 15 | Example | 0.5 h | Example | 0.5 h | 2 × corona | Example 4 | 0.5 h | 3.2 |
| | 2 | vaporisation | 1 | vaporisation | 1500 W | (solids 12 | vaporisation | |
| | | | | 1.0 h curing at | | wt. %) | 2.0 h curing at | |
| | | | | 130° C. | | | 130° C. | |

TABLE 3

| Example | Scratch-resistant | | | Application of the | Taber abrasion test |
|---|---|---|---|---|---|
| No. | sheet | Activation | Covering lacquer | covering lacquer | Clouding (%) |
| 16 | Lexan Margard ® | none | Example 4 | 0.5 h vaporisation | no adhesion |
| | MR 5 E | | (solids 13 wt. %) | 2.0 h curing at 130° C. | drips off |
| 17 | Lexan Margard ® | 2 × flaming | Example 4 | 0.5 h vaporisation | 4.0 |
| | MR 5 E | 3 m/min | (solids 13 wt. %) | 2.0 h curing at 130° C. | |
| 18 | Lexan Margard ® | 2 × corona 1500 W | Example 4 | 0.5 h vaporisation | 4.5 |
| | MR 5 E | | (solids 13 wt. %) | 2.0 h curing at 130° C. | |

Lexan Margard ® MR 5 E is a transparent, UV-resistant and abrasion-resistant material for flat glazing from General Electric Plastics GmbH, Rüsselsheim. The sheet has a double-coated surface.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A layered structure comprising in sequence a substrate, a scratch-resistant layer and a covering layer, wherein the scratch-resistant layer contains an at least partially cured polycondensate of a first reaction mixture that contains at least one silane, and wherein the covering layer contains a cured polycondensate of a second reaction mixture that contains a silane compound having at least one non-hydrolyzable substituent that carries an epoxy group.

2. The layered structure of claim 1 wherein the second reaction mixture comprises
A) at least one silicon compound which has at least one radical that is bonded directly to Si, is not able to be separated hydrolytically and contains an epoxy group,
B) a particulate material which is selected from the group consisting of oxides, oxide hydrates, nitrides and carbides of Si, Al, B and transition metals, and has a particle size of 1 to 100 nm,
C) a Si, Ti, Zr, B, Sn or V compound, which is different than compound A) and corresponds to the formula
RₓM⁴⁺R′₄₋ₓ
or
RₓM³⁺R′₃₋ₓ
wherein
M⁴⁺ represents Si⁴⁺, Ti⁴⁺, Zr⁴⁺, Sn⁴⁺,
M³⁺ represents B³⁺ or (VO)³⁺,
R represents a hydrolyzable radical,
R′ represents a non-hydrolyzable radical and
x is 1 to 4 in the case of quadrivalent metal atoms M and 1 to 3 in the case of trivalent metal atoms M and
D) at least one hydrolyzable Ti, Zr or Al compound corresponding to the formula
M(R′″)n
wherein
M represents Ti, Zr or Al,
R′″ represents the same or different hydrolyzable groups and
n is 4 when M is Ti or Zr and 3 when M is Al.

3. The layered structure according to claim 1 wherein the substrate comprise a polymeric resin.

4. The layered structure of claim 3 wherein the polymeric resin is polycarbonate.

5. The layered structure according to claim 1 wherein the silane of the first reaction mixture is methylsilane.

6. The layered structure according to claim 1 wherein the first reaction mixture contains 10 to 70 wt. % silica sol and 30 to 90 wt. % of a partially condensed organoalkoxysilane in an aqueous/organic solvent mixture, the percents both occurrences being relative to the solid content of the first reaction mixture.

7. The layered structure according to claim 1 wherein the first reaction mixture contains at least one silyl acrylate.

8. The layered structure according to claim 1 wherein the first reaction mixture contains methacryloxypropyltrimethoxysilane and A1O(OH) nanoparticles.

9. The layered structure according to claim 1 wherein the first reaction mixture contains at least one multifunctional cyclic organosiloxane.

10. The layered structure according to claim 2, wherein the second reaction mixture contains, per 1.0 mol. of the silicon compound (A), 0.2 to 1.2 mol. of the particulate materials (B), 0.2 to 1.2 mol. of the hydrolyzable compounds (C) and 0.1 to 0.7 mol. of the hydrolyzable compound (D).

11. The layered structure according to claim 10, wherein the silicon compound (A) has the formula
R₃SiR′
wherein
R independently one of the other represent a hydrolysable group, R′ is a glycidyl-alkylene radical or a glycidyloxy-(C₁₋₂₀)-alkylene radical, and wherein the particulate material (B) is an oxide or oxide hydrate of aluminium,
and wherein the hydrolyzable compound (C) has the formula
SiR″₄
wherein
R″ independently one of the others represents a hydrolysable group,
and wherein the hydrolyzable compound (D) is a compound of the formula
AIR₃
wherein the radicals R are the same or different and stand for a hydrolysable group, preferably a C₁₋₆-alkoxy group, a C₁₋₆-alkoxypropanolate group or a C₁₋₆-alkoxyethanolate group.

12. The layered structure according to claim 10 wherein the silicon compound (A) is γ-glycidyloxypropylsilane, the particulate material (B) is a sol of boehmite, the hydrolyzable compound (C) is tetraethoxysilane and the hydrolyzable compound (D) is Al(butoxyethanolate)₃.

13. The layered structure of claim 10 wherein the second reaction mixture additionally contains at least one Lewis base, and/or at least one hydrolysable silicon compound having at least one non-hydrolysable radical containing from 5 to 30 fluorine atoms which are bonded directly to carbon atoms and are separated from the Si by at least 2 atoms, and/or at least one surfactant, and/or at least one aromatic polyol having an average molecular weight of not more than 100 g/mol.

14. The layered structure according to claim 10, wherein the covering layer is prepared by a process comprising reacting a sol of the particulate materials having a pH of 2.5 to 3.5 with a mixture of said silicon compound and said hydrolyzable compound.

15. The layered structure according to claim 14 wherein the covering layer is prepared by a process which comprises
aa) mixing the silicon compound (A) and the hydrolyzable compound (C) to obtain a mixture and then
a) adding a first portion of from 10 to 70 wt. % of the total amount of said sol (B) to the mixture obtained in aa) and then
b) adding compound (D) of Ti, Zr or Al to the mixture obtained in a) and then
c) adding the remaining amount of said sol (B) to the mixture obtained in b).

16. The layered structure according to claim 15, wherein the addition in step a) is carried out at a temperature greater than 25° C. and the addition in step b) is carried out at 0 to 3° C. and in step c) at 0 to 5° C.

17. The layered structure according to claim 15, wherein the silicon compound optionally together with the hydrolyzable compound, is pre-hydrolysed using an acid catalyst.

18. The layered structure of claim 17 wherein acid catalyst is HCl.

19. The layered structure according to claim 1 wherein the scratch-resistant layer has a thickness of 0.5 to 30 μm.

20. The layered structure according to claims 1 wherein the covering layer has a thickness of 0.1 to 30 μm.

21. The layered structure according to claim 1 wherein the covering layer has a solids content of 30 to 5% relative to the weight of the covering layer.

22. The layered structure according to claim 1 wherein the second reaction mixture contains at least one solvent.

23. The layered structure of claim 22 wherein solvent is at least one member selected from the group consisting of water and alcohol.

24. The layered structure according to claim 1 additionally containing a primer layer.

25. The layered structure according to claim 1 wherein the scratch resistance of the covering layer in the Taber abrasion test is superior to the scratch resistance of the scratch-resistant layer.

26 The layered structure according to claim 1 wherein the covering layer exhibits a turbidity of <10% in the Taber abrasion test after 1000 cycles.

27. A process for the preparation of the layered structure according to claim 1 comprising
a) applying the first reaction mixture to the substrate and then
b) subjecting the first reaction mixture to conditions to effect partial drying, curing or polymerising to form a scratch resistant layer that contains reactive groups, and then
c) applying to the scratch-resistant layer the second reaction mixture and then
d) curing the second reaction mixture to form the covering layer.

28. The process according to claim 27, wherein scratch-resistant layer is activated prior to (c).

29. The process of claim 28 wherein the layer is activated by corona treatment, flaming or normal-pressure plasma.

30. The process according to claim 27 wherein the scratch-resistant layer is thermally dried at a temperature greater than 20° C.

31. The process according to claim 27 wherein the covering layer is dried at a temperature greater than 110° C.

32. The process according to claim 27 further comprising applying a primer layer to the substrate prior to (a).
